(19) United States
(12) Patent Application Publication
(10) Pub. No.: US 2011/0128146 A1
(43) Pub. Date: Jun. 2, 2011

(54) CARING SYSTEM AT HOME

(75) Inventors: Ya-Hsin Hsueh, Taichung (TW); Kuan-Wei Chen, Taipei (TW)

(73) Assignee: National Yunlin University of Science & Technology, Yunlin (TW)

(21) Appl. No.: 12/628,116

(22) Filed: Nov. 30, 2009

(51) Int. Cl. G08B 23/00; G08B 1/08

(52) U.S. Cl. 340/539.12; 340/573.1

(57) ABSTRACT

A caring system at home having two-way wireless network and reminding & warning functions is disclosed. The caring system at home includes a physiological signal measuring instrument, a wireless integrated control module, a reminding & warning device, a graphic user's interface system, as well as a database server. The physiological signal measuring instrument transmits the measured results to the graphic user interface for displaying through the wireless two-way transmitting module and stores the data in the database server for collecting, analyzing, and data-inquiring. The wireless two-way transmitting module is capable of receiving the signals transmitted by the graphic user interface to accomplish the reminding & warning functions. In addition, the mobile device transmitting module transmits the reminding & warning information to the mobile device.

### BACKGROUND OF THE INVENTION

1. Field of the Invention

The invention relates to a caring system at home, and more particularly, to a caring system at home having two-way wireless network and reminding & warning functions.

2. Description of the Prior Art

Recently by the influence of world aging population and fewer children, the worldwide population is aging faster than ever. According to the UN website data, elderly people over 65-year-old was 7.3% of the world population in 2005 and will rise to 10.5% in 2025, and will even rise to 16.2% in 2050. However, the population of the teenagers under 15-year-old is down from 1970 and will be reduced further each year. The young population is around 28.3% in 2005 and will be deduced down to 19.8% in 2050. As the population of the elderly people keeps on increasing, the social welfare problems will be more complicated. Therefore, just how to provide a convenient ways to take care of the elderly people has become a key issue for the medicare industry.

The conventional measured data by the use of the physiological signal measuring instrument needs to collect their record by human labor, and have the collected data pass to the relevant personnel for performing analysis and judgment. For those elderly people with health conditions that are chronic and needed to have longtime medicare becomes tedious and troublesome since the record can be incomplete or full of errors.

Recently, part of the physiological signal measuring instruments have the wireless transmitting functions that is capable of transmitting the measured results to the personal computers (PC) and personal digital assistant (PDA) through the wireless transmission such as the Taiwan Patent No. I294280, The various relevant products in the market having different brands are mostly not compatible as they are different in specification. This is pretty much inconvenient foe the users. A remote caring system is also developed such as Taiwan patent no. 200806251 that is capable of transmitting the physiological data to the center processing unit through internet or other channels. Therefore, the above-mentioned products have only the recording and measuring functions without the time-set reminding and warning features.

### SUMMARY OF THE INVENTION

In light of the disadvantages of the prior arts, the invention provides a multi-function probe card that aims to ameliorate at least some of the disadvantages of the prior art or to provide a useful alternative.

It is an objective of the invention to provide a caring system at home that includes a physiological signal measuring instrument, a wireless integrated control module, a reminding & warning device, a graphic user's interface system, and a database server. The physiological signal measuring instrument transmits the measured results to the graphic user interface for displaying through the wireless two-way transmitting module and stores the data in the database server to be stored, analyzed, and for future inquiry. The graphic user's interface system is capable of judging if the received data exceeds the normal range or if the received data reach the set reminding time of the user in order to transmit information to the wireless integrated control module and wireless two-way transmitting module to achieve reminding and warning efficacies.

It is another objective of the invention to provide a wireless integrated control module that includes a microprocessing controller, wireless two-way transmitting module, a reminding and warning unit, an interface module, and a display unit.

It is a further objective of the invention to provide a graphic user's interface system that includes a wireless two-way transmitting module, a window interface software program, a graphic user's interface system, an internet, and a mobile device transmitting module.

It is a further objective of the invention to provide an operating method for the caring system at home includes the following steps:
1. Measuring the physiological data by the physiological signal measuring instrument and then transmitting the physiological data to the wireless integrated control module;
2. Transmitting the received physiological data, after being processed through the microprocessing controller, to the graphic user's interface system;
3. Transmitting the received physiological data of the graphic user's interface system from the wireless integrated control module, after the format being transformed through the window interface software program, to the database server;
4. Setting the time setting issue reminding function by the graphic user's interface system for transmitting physiological data to the pre-assigned personnel;
5. Acquiring the physiological data in the database server through the graphic user's interface system and observing its content on the visible device.

To attain the above-mentioned objectives, the invention provides a caring system at home The caring system at home includes a physiological signal measuring instrument, a wireless integrated control module, a reminding & warning device, a graphic user's interface system, as well as a database server. The physiological signal measuring instrument transmits the measured results to the graphic user interface for displaying through the wireless two-way transmitting module and stores the data in the database server for collecting, analyzing, and data-inquiring. The wireless two-way transmitting module is capable of receiving the signals transmitted by the graphic user interface to accomplish the reminding & warning functions. In addition, the mobile device transmitting module transmits the reminding & warning information to the mobile device.

### BRIEF DESCRIPTION OF THE DRAWINGS

The accomplishment of this and other objectives of the invention will become apparent from the following description and its accompanying drawings of which:

FIG. 1 is a schematic diagram of the caring system at home of the invention;

FIG. 2 is a schematic diagram of the physiological signal measuring instrument of the caring system at home of the invention;

FIG. 3 is a schematic diagram of the wireless integrated control module of the caring system at home of the invention;

FIG. 4 is a schematic diagram of the framework of the wireless integrated control module of the caring system at home of the invention;

FIG. 5 is a schematic diagram of the framework of the graphic user's interface system of the caring system at home of the invention; and

FIG. 6 is a schematic diagram of the framework of the window interface software program of the caring system at home of the invention.

### DETAILED DESCRIPTION OF THE PREFERRED EMBODIMENT

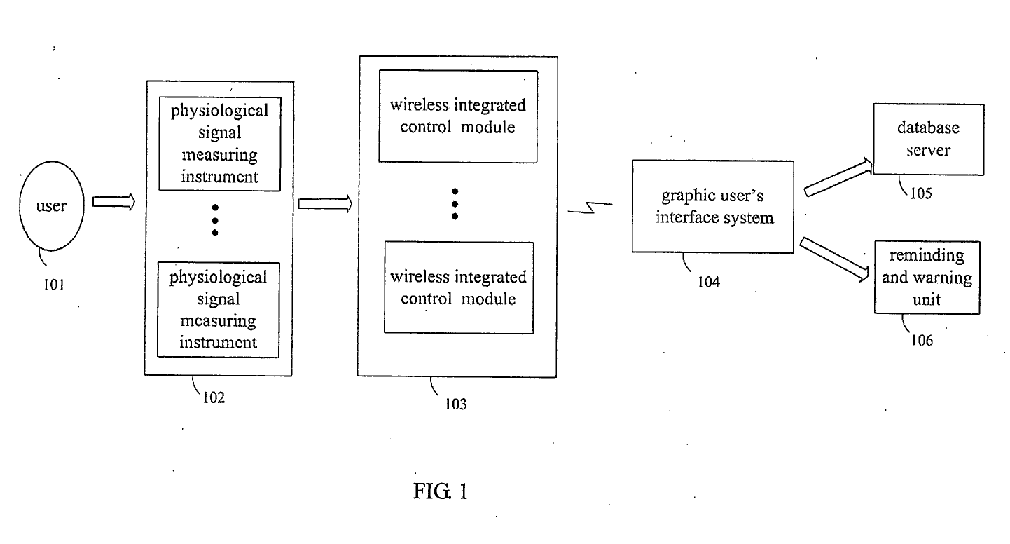

FIG. 1 is a schematic diagram of the caring system at home of the invention. As shown in FIG. 1, the preferred embodiment of the caring system at home of the invention includes a physiological signal measuring instrument (102), a wireless integrated control module (103), a reminding and warning unit (106), a graphic user's interface system (104), and a database server (105). A user (101) performs measuring work by use of the physiological signal measuring instrument (102) and transmits the measured result to the graphic user's interface system (104) through the wireless integrated control module (103). The graphic user's interface system (104) instantly displays the physiological data and stores the physiological data in the database server (105) through the internet. The database server (105) has the physiological data store, analyze, and provide later-on inquiry. If the physiological signal received by the graphic user's interface system (104) exceeds the normal range, the reminding and warning unit (106) will be driven to send e-mail and message to the emergency liaison person or medicare unit so as to achieve the warning function. The graphic user's interface system (104) is capable of setting a timing reminding to transmit the warning signal to the wireless integrated control module (103) so as to achieve reminding function.

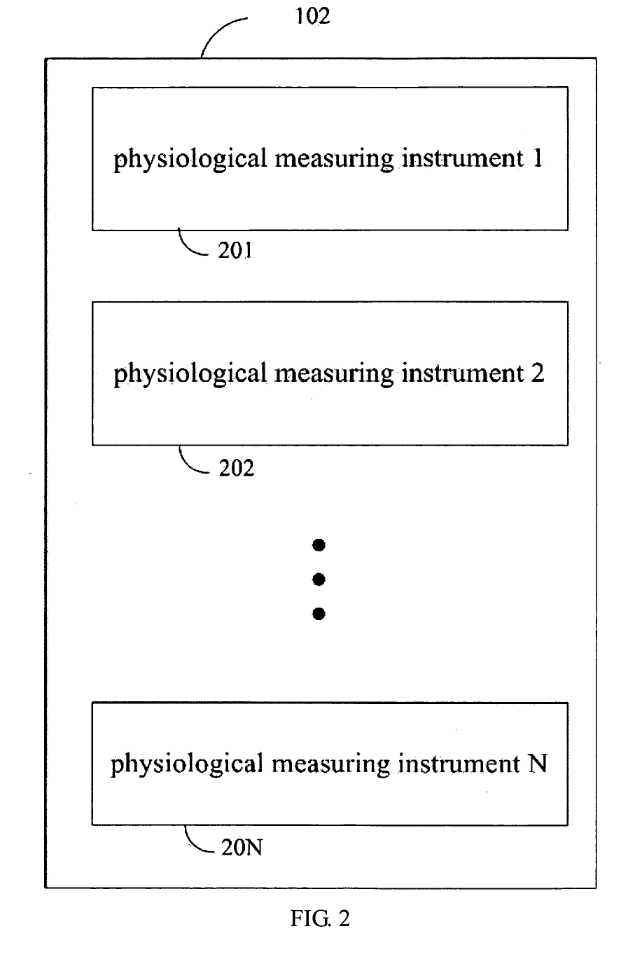

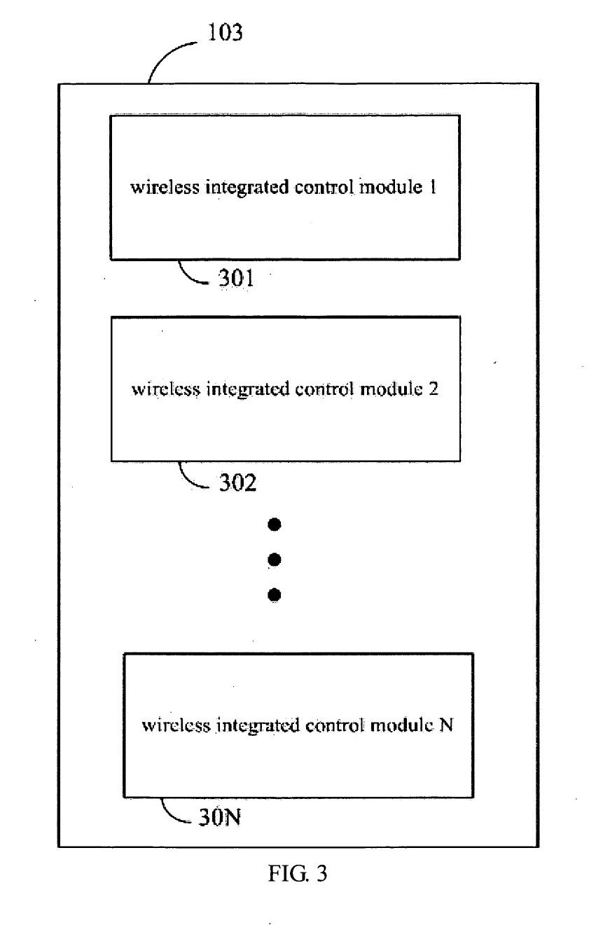

FIG. 2 is a schematic diagram of the physiological signal measuring instrument of the caring system at home of the invention while FIG. 3 is a schematic diagram of the wireless integrated control module of the caring system at home of the invention. As shown in FIG. 1, FIG. 2, and FIG. 3, there are various types of physiological signal measuring instruments (102) that are capable of including a plurality of physiological signal measuring instruments (102): physiological signal measuring instrument (201), physiological signal measuring instrument (202)—physiological signal measuring instrument (20N) etc. Similarly, there are multiple set of wireless integrated control modules (103): wireless integrated control module (301), wireless integrated control module (302), wireless integrated control module (30N) etc. When it comes to use, for instance, the user (101) may choose a set of physiological signal measuring instrument (102) in corresponding with a set of wireless integrated control module (103) or a multiplicity of physiological signal measuring instruments (102) in corresponding with a set of wireless integrated control module (103).

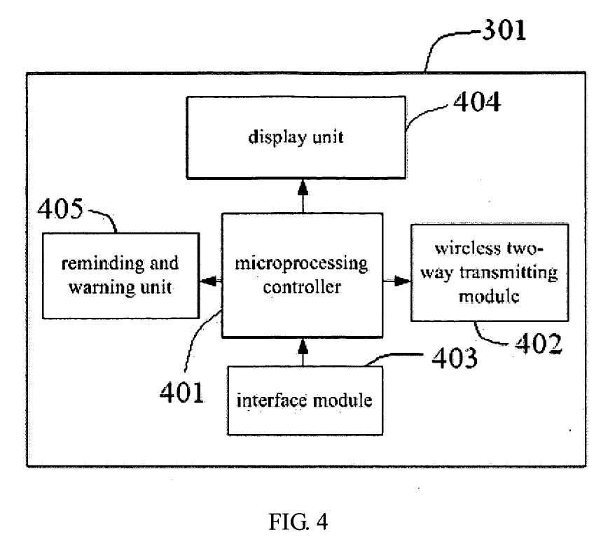

FIG. 4 is a schematic diagram of the framework of the wireless integrated control module of the caring system at home of the invention. As shown in FIG. 1, FIG. 3, and FIG. 4, the wireless integrated control module (103) including the wireless integrated control modules (301), (302),—(30N) includes a microprocessing controller (401), a wireless two-way transmitting module (402), an interface module (403), a display unit (404), and a reminding and warning unit (405). The physiological signal measuring instrument (102) transmits the measured physiological data to the microprocessing controller (401) of the wireless integrated control module (103) through the interface module (403). The microprocessing controller (401) drives the display unit (404), displays the physiological data thereon, has the physiological data transform into the format required by the wireless two-way transmitting module (402), and transmits the physiological data to the graphic user's interface system (104). If the physiological data received by the microprocessing controller (401) do not conform to the range of normal value, the reminding and warning unit (405) will be driven to achieve the warning function. The reminding and warning unit can be a warning light, a sounding device, an electric stimulator, or a display device.

The microprocessing controller (401) of the wireless integrated control module (103) can be a microprocessor, a microcontroller, a single chip, a digital signal processor (DSP), a system-on-chip (SOC), an embedded-type chip, or a field programmable Gate Array (FPGA) chip.

The wireless two-way transmitting module (402) being a communication protocol can be a RF, a Bluetooth, a ZigBee, a RFID, an IrDA, or an IEEE802.11.

The interface module being a transmission protocol can be a Universal Series Bus (USB), a Universal Asynchronous Receiver/Transmitter (UART), a RS232 (Recommended Standard 232), an Inter-Integrated Circus Bus(I²C), or a Serial peripheral Interface Bus (SPI).

The graphic user's interface system (104) also transmits physiological data to the wireless integrated control module (103) through wireless transmission. The wireless integrated control module (103) receives wireless transmission signal from the wireless two-way transmitting module (402) then transmits the received signal to the microprocessing controller (401) that displays the signal on the display unit (404) or drives the reminding and warning unit (405) to achieve reminding and warning effects.

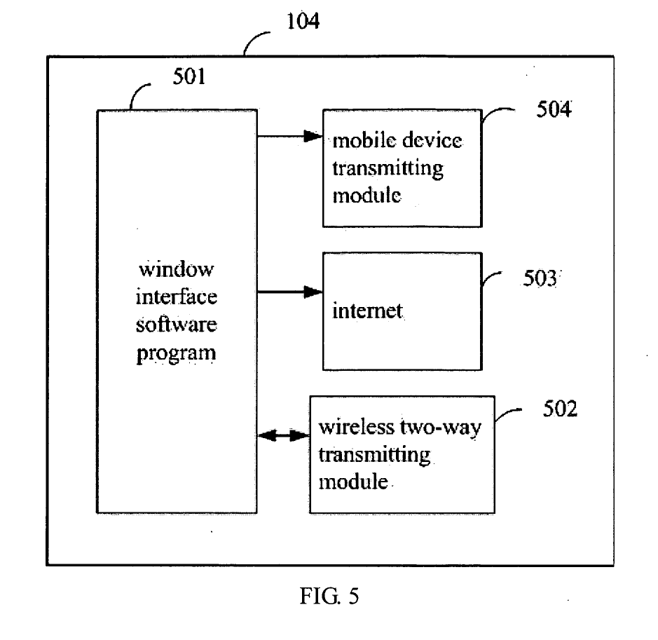

FIG. 5 is a schematic diagram of the framework of the graphic user's interface system of the caring system at home of the invention. As shown in FIG. 5, the graphic user's interface system (104) includes a wireless two-way transmitting module (502), a window interface software program (501), an internet (503), and a mobile device transmitting module (504). The graphic user's interface system (104) receives the physiological data transmitted from the wireless integrated control module (103) and instantly displays the physiological data on the window interface software program (501), thereafter transmits the physiological data to the database server (105) to be stored, analyzed, and ready for later-on inquiry. If the value of the physiological data exceeds the normal range, a warning signal will be set off. The warning signal can also be sent as an e-mail through the internet (503) or be sent as a message through the mobile device transmitting module (504) to the emergency liaison person or medicare unit.

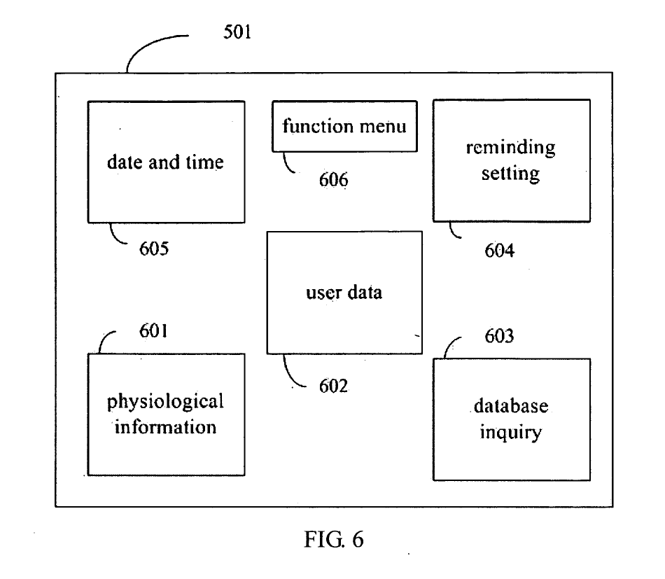

FIG. 6 is a schematic diagram of the framework of the window interface software program of the caring system at home of the invention. As shown in FIG. 6, the window interface software program (501) includes a physiological data (601), user's data (602), a database inquiry (603), reminding setting (604), date and time (6051), and function menu (606). The graphic user's interface system (104) possesses the function of reminding setting (604) that can be transmitted to the reminding and warning unit (405) of the wireless integrated control module (103) through the wireless two-way transmitting module (502) to achieve the function for reminding the user. The user (101) can also make use of the function of the database inquiry (603) of the window interface software program (501) to acquire the physiological data, analysis data or to observe the analysis results directly on the window interface software program (501). The window interface software program (501) is also capable of displaying thereon the date and time (605) and other function menu (606).

An operating method for the caring system at home includes the following steps:
1. Measuring the physiological data by the physiological signal measuring instrument and then transmitting the physiological data to the wireless integrated control module;
2. Transmitting the received physiological data, after being processed through the microprocessing controller, to the graphic user's interface system;
3. Transmitting the received physiological data of the graphic user's interface system from the wireless integrated control module, after the format being transformed through the window interface software program, to the database server;
4. Setting the time setting issue reminding function by the graphic user's interface system for transmitting physiological data to the pre-assigned personnel;
5. Acquiring the physiological data in the database server through the graphic user's interface system and observing its content on the visible device.

### THE EFFICACIES OF THE INVENTION

As compare with the prior art, in order to assure correct observation on data collection, a caring system suitable for conforming various situations becomes necessary to study and develop. These new products need to be able to accommodate the physiological signal measuring instruments to transmit the measured signal to the PC through the microprocessing controller and wireless two-way transmitting module and instantly display graphic user's interface system. The physiological data are then transmitted to a remote database server through the internet to be analyzed, stored, and ready for later-on inquiry. The products also possess time-set reminding function that is capable of setting off reminding signal for the user. In addition, the products are capable of sending information to the mobile device through the internet when the value of the measured physiological data exceeds the normal range.

### CONCLUSION OF THE INVENTION

The caring system at home of the invention having the feature of wireless two-way transmission and the functions of reminding and warning is very much applicable to be used at home and medicare relevant medicare industry.

It will become apparent to those people skilled in the art that various modifications and variations can be made to the structure of the invention without departing from the scope or spirit of the invention. In view of the foregoing description, it is intended that all the modifications and variation fall within the scope of the following appended claims and their equivalents.

1. A caring system at home, comprising:
a physiological signal measuring instrument for a user to measure a physiological signal for acquiring physiological data;
a wireless integrated control module, that is connected to the physiological signal measuring instrument, having the functions of instant display and having the function of reminding and warning;
a graphic user's interface system for transmitting or receiving physiological data together with the wireless integrated control module through the wireless two-way transmission; and
a database server for storing, analyzing, or later-on inquiring the physiological data received through an internet and transmitted by the graphic user's interface system.

2. The caring system at home as claimed in claim 1, wherein the graphic user's interface system displays the received physiological data on a window interface.

3. The caring system at home as claimed in claim 1, wherein when the physiological signal exceeds normal value, the user communicates with an emergency liaison person or medicare unit.

4. The caring system at home as claimed in claim 1, wherein a reminding function timing is set in order to transmit the physiological data to the wireless integrated control module and/or the pre-assigned personnel.

5. The caring system at home as claimed in claim 1, wherein the physiological signal measuring instrument is selected from the group consisting of a portable-type device and desk-top device.

6. The caring system at home as claimed in claim 1, wherein the wireless integrated control module further comprising:
interface module;
wireless two-way transmitting module, having a specific transmitting format;
display unit, for displaying physiological data;
microprocessing controller, acquiring physiological data obtained from the physiological signal measuring instrument in claim 1, through the interface module; transforming the physiological data into the transmitting format of the wireless two-way transmitting module; and then transmitting to the graphic user's interface system in claim 1; and
reminding and warning unit for transmitting a warning signal when the physiological signal exceeds normal value.

7. The caring system at home as claimed in claim 1, wherein the wireless integrated control module receives physiological data from the graphic user's interface system through the wireless two-way transmitting module and displays the received physiological data on a display unit.

8. The caring system at home as claimed in claim 3, wherein the wireless integrated control module receives physiological data from the graphic user's interface system through the wireless two-way transmitting module and drives the reminding and warning unit to transmit a reminding signal.

9. The caring system at home as claimed in claim 6, wherein the wireless two-way transmitting module is a communication protocol selected from the group consisting of RF, Bluetooth, ZigBee, RFID, IrDA, and IEEE802.11.

10. The caring system at home as claimed in claim 6, wherein the microprocessing controller of the wireless integrated control module is selected from the group consisting of a microprocessor, a microcontroller, a single chip, a digital signal processor (DSP), a system-on-chip (SOC), an embedded-type chip, and a field programmable Gate Array (FPGA) chip.

11. The caring system at home as claimed in claim 6, wherein the display unit is a visible device selected from the group consisting of an LED display, an LCD display, an organic light emitting diode (OLED) display, an Electroluminescent display, an electronic paper, and a seven-segment display.

12. The caring system at home as claimed in claim 6, wherein the interface module is a transmission protocol selected from the group consisting of a Universal Series Bus (USB), a Universal Asynchronous Receiver/Transmitter (UART), a RS232 (Recommended Standard 232), and an Inter-Integrated Circus Bus (I²C) and a Serial peripheral Interface Bus (SPI).

13. The caring system at home as claimed in claim 6, wherein the reminding and warning unit is selected from the group consisting of a warning light, a sounding device, an electric stimulator, and a display device.

14. The caring system at home as claimed in claim 1, wherein the graphic user's interface system further comprising:
a wireless two-way transmitting module, transmitting warning information to the wireless integrated control module to achieve warning effect, setting timing issue to perform warning; and performing reminding effect when the setting time is arrived;
a window interface software program, receiving the physiological data, transmitted by the wireless integrated control module, through the wireless two-way transmitting module; the window interface software program also displaying the received physiological data;
an internet, transmitting the physiological data to be stored, analyzed, or for inquiry later on; transmitting E-mail through if the received physiological data exceed normal value; and performing reminding effect when the setting time is arrived; and
a mobile device transmitting module, transmitting warning information to the wireless integrated control module to achieve warning effect and performing reminding effect when the setting time is arrived.

15. The caring system at home as claimed in claim 14, wherein the window interface software program has a function that is selected from the group consisting of displaying physiological data, physiological data, reminding setting, data inquiry, date-and-time, functional menu, and version data.

16. A caring system at home, comprising:
a physiological signal measuring instrument for a user to measure a physiological signal for acquiring physiological data;
a wireless integrated control module, that is connected to the physiological signal measuring instrument, having the functions of instant display and having the function of reminding and warning; and
a database server, receiving the physiological data from the wireless integrated control module transmitted through wireless two-way transmitting module, and after been processed, storing to the databases for analyzing, or later-on inquiring the physiological data; when the physiological signal exceeds normal value, the user communicates with an emergency liaison person or medicare unit; and the database server also displaying the received physiological data thereon.

17. The caring system at home as claimed in claim 16, wherein the wireless integrated control module further comprising:
an interface module;
a wireless two-way transmitting module, having a specific transmitting format;
a display unit, for displaying physiological data;
a microprocessing controller, acquiring physiological data obtained from the physiological signal measuring instrument, through the interface module; transforming the physiological data into the transmitting format of the wireless two-way transmitting module; and then transmitting to the database server; and
a warning unit for transmitting a warning signal when the physiological signal exceeds normal value.

18. The caring system at home as claimed in claim 17, wherein the database server further comprising:
a wireless two-way transmitting module, for transmitting the warning information, judged by the database server in when the physiological data is abnormal within the normal range, to the wireless integrated control module to achieve the warning effect;
a database, for storing the physiological data after being processed where the physiological data are transmitted by the wireless integrated control module and received through the wireless two-way transmitting module, and for using the physiological data stored therein to analyze and for inquiry;
a display unit, for displaying the processed physiological data;
an internet, for transmitting the warning information, judged by the database server when the physiological data is abnormal within the normal range, to the wireless integrated control module to achieve the warning effect; and
a mobile device transmitting module, for transmitting the warning information, judged by the database server in when the physiological data is abnormal within the normal range, to the wireless integrated control module to achieve the warning effect.

19. An operating method for the caring system at home as claimed in claim 1, comprising the following steps:
measuring the physiological data by the physiological signal measuring instrument and then transmitting the physiological data to the wireless integrated control module;
transmitting the received physiological data, after being processed through the microprocessing controller, to the graphic user's interface system;
transmitting the received physiological data of the graphic user's interface system from the wireless integrated control module, after the format being transformed through the window interface software program, to the database server;
setting the time setting issue reminding function by the graphic user's interface system for transmitting physiological data to the pre-assigned personnel; and
acquiring the physiological data in the database server through the graphic user's interface system and observing its content on the visible device.

20. The operating method for the caring system at home as claimed in claim 19, wherein the processing method for the wireless integrated control module comprising the following steps:
receiving the physiological data measured by the physiological measuring instrument and transforming the transmitting format of the wireless two-way transmitting module, then transmitting the physiological data with the transmitting format; and
judging the if the received physiological data are abnormal within the normal range, then driving the warning function of the wireless integrated control module if the physiological data are abnormal.

21. The operating method for the caring system at home as claimed in claim 19, wherein the operating method for the graphic user's interface system comprising the following steps:
receiving the data from the wireless integrated control module and acquiring the physiological data through the transformation by the window interface software program;
transmitting the physiological data through the internet to the database server for storing, analyzing and for later-on inquiry or displaying on the pictures of the window interface software program;
judging if the physiological data are abnormal with the range of the normal range; and
driving and transmitting the physiological data through the graphic user's interface system to the pre-assigned unit for achieving the warning function.

22. The operating method for the caring system at home as claimed in claim 19, wherein the operating method for the issue reminding of graphic user's interface system comprising the following steps:
setting the desired time and issue on the graphic user's interface system; and
driving and transmitting the physiological data to the pre-assigned unit for achieving the warning function.

23. The operating method for the caring system at home as claimed in claim 19, wherein the readable form of the data inquiry content of the database is selected from the group consisting of number, letter, and graphic form.

24. The operating method for the caring system at home as claimed in claim 19, wherein the visible device for the database inquiry is selected from the group consisting of an LCD display, a screen of a mobile device, and a Personal Digital Assistant (PDA).

25. The operating method for the caring system at home as claimed in claim 19, wherein the method for judging if the physiological data is abnormal within the normal range comprising the following steps:
driving the warning function of the wireless integrated control module if the judgment of abnormal is “yes”, and
continuing to detect the next set of physiological data if the judgment of abnormal is “no”.

26. The operating method for the caring system at home as claimed in claim 19, wherein the warning function is a sensible device selected from the group consisting of luminous device, a sounding device, an electric stimulator, and a display device.

27. The operating method for the caring system at home as claimed in claim 19, wherein the transmitted information is either an e-mail or a message from a mobile device.

28. The operating method for the caring system at home as claimed in claim 19, wherein the preset notifying unit is either an emergency liaison person or a medicare unit.

29. The operating method for the caring system at home as claimed in claim 19, wherein the information transmitting is selected from the group consisting of an e-mail, a message from a mobile device, and transmitting signal to the wireless integrated control module.
